(19) United States
(12) Patent Application Publication
(10) Pub. No.: US 2008/0286725 A1
(43) Pub. Date: Nov. 20, 2008

(54) Electrical Power Converter for a Simulated Weapon Device

(76) Inventors: Giles D. Jones, Chino Hills, CA (US); Bradley Huang, Chino Hills, CA (US); Jeffrey E. Decker, Moreno Valley, CA (US); Qingce Bian, Corona, CA (US); Christopher A. Tomlinson, Vail, AZ (US); William W. Price, Upland, CA (US); Peter M. Wallrich, Upland, CA (US)

Correspondence Address: BAKER BOTTS LLP, 2001 ROSS AVENUE, 6TH FLOOR, DALLAS, TX, 75201-2980, US

(21) Appl. No.: 11/748,351

(22) Filed: May 14, 2007

(51) Int. Cl. F41G 3/26; H02P 13/00

(52) U.S. Cl. 434/21; 363/100

(57) ABSTRACT

In one embodiment according to the present disclosure, a military training apparatus generally includes an electrical power converter for coupling between a simulated weapon device and an electrical power system of a vehicle. The electrical power system has at least one operating characteristic that is incompatible with the simulated weapon device. The electrical power converter is operable to receive electrical power from the electrical power system and adjust the electrical power provided to the simulated weapon device such that an operating characteristic of the simulated weapon device remains within one or more specified limits.

### TECHNICAL FIELD OF THE DISCLOSURE

This disclosure relates in general to electrical power devices, and more particularly to a electrical power converter for a simulated weapon device and a method of operating the same.

### BACKGROUND OF THE DISCLOSURE

Various simulated weapon devices have been developed to simulate tactical military combat maneuvers. One particular type of simulated weapon device adopted for use by the armed forces is the multiple integrated laser engagement system (MILES). The multiple integrated laser engagement system is generally a system of laser transmitters that work in conjunction with one or more laser receivers to simulate various tactical combat actions, such as the operation of firearms or exploding bombs on various targets. These laser transmitters may be configured in various types of simulated weapon attack devices, such as firearms, bombs, rocket launchers, canons, tanks, and the like in which the laser transmitter may emit a laser signal indicative of the weapon's capability. Laser receivers may be used in other various simulated weapon impact devices that are operable to register a “hit” when triggered by a simulated weapon attack device. The simulated weapon impact device may be an article of clothing, or any other suitable device used by combat personnel.

### SUMMARY OF THE DISCLOSURE

In one embodiment according to the teachings of the present disclosure, a military training apparatus generally includes an electrical power converter for coupling between a simulated weapon device and an electrical power system of a vehicle. The electrical power system has at least one operating characteristic that is incompatible with the simulated weapon device. The electrical power converter is operable to receive electrical power from the electrical power system and adjust the electrical power provided to the simulated weapon device such that an operating characteristic of the simulated weapon device remains within one or more specified limits.

Some embodiments of the disclosure provide numerous technical advantages. Some embodiments may benefit from some, none, or all of the below-described advantages. For example, according to one embodiment of the disclosure, an electrical power converter is provided that alleviates the need for ancillary power sources, such as batteries to power one or more simulated weapon devices configured on the vehicle. For vehicles having a generally non-standard electrical power system, electrical power for the simulated weapon device could only be provided by an ancillary battery that was separate from the vehicle's electrical power system. This limitation caused other problems, such as the necessity of ensuring the charge level of the ancillary battery prior to usage and/or performing routine maintenance to ensure proper operation. The electrical power converter of the present disclosure may provide a solution to these problems by converting electrical power from the electrical power system of the vehicle to a form that is within the specified limits of the simulated weapon device.

Other advantages may be readily apparent to one of skill in the art.

### BRIEF DESCRIPTION OF THE DRAWINGS

For a more complete understanding of the present disclosure and its advantages, reference is now made to the following description, taken in conjunction with the accompanying drawings, in which:

FIG. 1 is a perspective view of one embodiment of an electrical power converter that is coupled between a simulated weapon device and an electrical power system of a vehicle;

FIG. 2 is a block diagram showing several components the electrical power converter of FIG. 1; and

FIG. 3 is a flowchart showing several actions that may be performed by the electrical power converter to supply electrical power to a simulated weapon device using the electrical power system of the vehicle.

### DETAILED DESCRIPTION OF THE PRESENT DISCLOSURE

Simulated weapon devices used in simulated weapon training may be configured to resemble equipment encountered during an actual combat maneuver. In this manner, combat personnel may be trained to readily recognize the difference between friend, civilian, or foe personnel due to visual or other sensory characteristics provided by the simulated weapon device. Simulated weapon attack devices that simulate offensive actions and their complementary simulated weapon impact devices that indicate receipt of such offensive actions shall be collectively referred to as simulated weapon devices due to their generally common purpose.

One particular type of simulated weapon impact device that may used in simulated weapon training is a vehicle. Use of the vehicle in simulated weapon training may provide for enhanced simulation of actual conditions that may occur on a battlefield situation. These vehicles may be domestic or foreign military vehicles, such as jeeps, armored personnel carriers (APCs), infantry fighting vehicles (IFVs), or tanks. Vehicles used in simulated weapon training may also be civilian vehicles due to the various tactics recently used by enemy combatant forces. Examples of civilian vehicles that may be used in simulated weapon training includes, sedans, coupes, trucks, motorcycles, and the like.

To enhance the simulation of these combat maneuvers, actual working vehicles that may potentially be seen in a combat situation may be implemented for use in the simulated weapon exercise. That is, use of various types of vehicles may train combat personnel to recognize whether a particular vehicle is a friend, civilian, or foe based upon the visual appearance or sound generated by the vehicle. These vehicles, however, may not have an electrical power system suitable for providing electrical power to a simulated weapon device configured on the vehicle. For example, many foreign vehicles may incorporate an electrical power system with a nominal voltage that differs from the nominal voltage used by the simulated weapon device. Additionally, the electrical power systems in these foreign vehicles may be susceptible to frequent voltage surges, spikes, and/or power cut-outs and are therefore, generally unsuitable for use with simulated weapon devices that may include computer related circuitry.

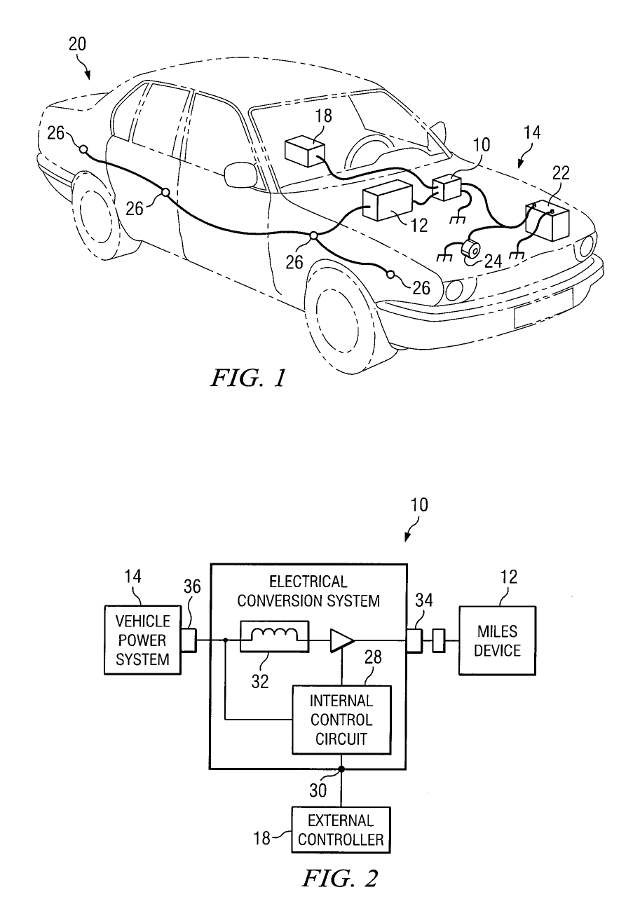

FIG. 1 shows one embodiment of an electrical power converter 10 that may provide a solution to providing electrical power to simulated weapon devices from the electrical power system of various vehicles as well as other problems. Electrical power converter 10 is coupled between a simulated weapon device 12 and an electrical power system 14 of a simulated weapon device enabled vehicle 20. Electrical power converter 10 may also be coupled to an external controller 18 for controlling the operation of the electrical power converter 10. As will be described in detail below, electrical power converter 10 may be operable to provide a generally reliable source of electrical power for simulated weapon device 12 configured on vehicles that do not a have a suitable nominal voltage level, a proper polarity, or is otherwise generally unsuitable for directly providing electrical power to simulated weapon devices 16.

Electrical power system 14 may be any electrical power system that is configured to provide electrical power to simulated weapon device enabled vehicle 20. Electrical power system 14 may include a battery 22 for storage of electrical power and may also include a generator 24 for generating electrical power that is derived from mechanical power of the vehicle's engine. The simulated weapon device enabled vehicle 20 may be any type of vehicle as described above. Electrical power converter 10 may be operable to convert electrical power from electrical power system 14 of virtually any vehicle to a source of electrical power suitable for use with simulated weapon device 12.

In one embodiment, simulated weapon device 12 is a military integrated laser engagement system (MILES) device. The military integrated laser engagement system device may include a transmitter for transmission of electromagnetic radiation or may include a receiver for receipt and recognition of such electro-magnetic signals. A particular military integrated laser engagement system device configured with a transmitter may be operable emit a relatively short burst of electro-magnetic energy in response to actuation by combat personnel. The military integrated laser engagement system also includes a simulated weapon device 12 that may be configured on simulated weapon device enabled vehicle 20 for simulating an impact from another simulated weapon device (not specifically shown). For example, another simulated weapon device, such as a grenade launcher may be distally located from simulated weapon device enabled vehicle 20 and operable to transmit electromagnetic signals simulating an attack upon the simulated weapon device enabled vehicle 20.

In one embodiment, simulated weapon device 12 may include a transmitter or a receiver for simulating an attack by an offensive weapon or simulating an impact from the weapon, respectively. Examples of attack weapons may include, for example, rifles, handguns, machine guns, canons, or bombs. In a particular embodiment in which simulated weapon device 12 is operable to simulate an impact, the simulated weapon device enabled vehicle 20 may be configured with a number of receivers 26 that may be used to simulate a “hit” from another simulated weapon device. In another example, the simulated weapon device enabled vehicle 20 may be a tank and the simulated weapon device 12 may have a laser transmitter that is configured on the barrel of the tank's main gun.

In one embodiment in which the simulated weapon device 12 is a military integrated laser engagement system device, electrical power converter 10 may be operable to provide electrical power having a specified nominal voltage level of twenty-four volts direct-current (VDC). In another embodiment, electrical power converter 10 may be operable to provide a electrical power that is current rated to six amperes.

FIG. 2 is a block diagram showing several features of one embodiment of electrical power converter 10 according to the teachings of the present disclosure. Electrical power converter 10 may include an internal control circuit 28 that is coupled to a port 30 for enabling control of the operation of the electrical power converter 10 from external controller 18. Internal control circuit 28 may be coupled to external controller 18 through the port 30 using any suitable protocol. In one embodiment, port 30 may include a single conductor that is configured to interpret a voltage level from external controller 18 as corresponding to a logic level, such as transistor-transistor logic (TTL) level or complementary metal-oxide semiconductor (CMOS) logic level. In other embodiments, port 30 may be a communication port, such as a RS-232 port or a universal serial bus (USB) port for transferring control information from external controller 18 to the internal control circuit 28.

The electrical power converter 10 may have a relatively wide input voltage range in order to accommodate the voltage levels provided by various electrical power systems 14. That is, the electrical power converter 10 may have an input voltage range that is configured to accept electrical power from various types of vehicles that have non-standard nominal voltage levels. In one embodiment, electrical power converter 10 may have an input voltage range of 10.5 to 32.0 volts direct-current. This input voltage range may be able to accommodate various electrical power systems 14 having nominal voltage levels, such as twelve or twenty-four volts direct-current. In one embodiment, electrical power converter 10 may incorporate a surge suppression circuit 32 for canceling electrical noise or voltage spikes from being transferred from electrical power system 14 to the simulated weapon device 12. In another embodiment, surge suppression circuit 32 may be an inductor or a choke.

In one embodiment, internal control circuit 28 is operable to determine the polarity of the electrical power provided by electrical power system 14 and adjust the output voltage level such that electrical power having a particular polarity, such as positive or negative polarity, is always provided to the simulated weapon device 12. In a particular embodiment in which simulated weapon device 12 is a military integrated laser engagement system device, the electrical power converter 10 may be operable to provide a positive polarity to the simulated weapon device 12 in spite of the polarity of the electrical power system 14. Certain embodiments incorporating an automatic polarity adjusting system may provide an advantage when used in conjunction with some foreign vehicles that utilize positive ground electrical power systems 14.

The electrical power converter 10 may be coupled to the simulated weapon device 12 using any suitable electrical connection mechanism. In one embodiment, electrical power converter 10 may include a radio rack compliant receptacle 34 that is similar to receptacles found on radio racks of domestic military vehicles. In this manner, simulated weapon devices 16 having a radio rack compliant connector may be coupled to the electrical power converter 10 in a relatively easy manner. Electrical power converter 10 may also be coupled to electrical power system 14 of the simulated weapon device enabled vehicle 20 using any suitable connection mechanism. In one embodiment, the electrical power converter 10 may incorporate battery terminal posts 36 for connection to electrical power system 14.

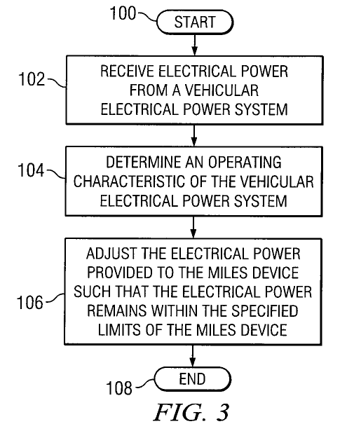

FIG. 3 shows a series of actions that may be performed by the electrical power converter 10 according to one embodiment of the present disclosure. In act 100, the process is initiated. The process may be initiated by coupling electrical power converter 10 between the electrical power system 12 of a simulated weapon device enabled vehicle 20 and one or more simulated weapon devices 14.

In act 102, the electrical power converter 10 receives electrical power from the electrical power system 14. The electrical power system 14 has at least one operating characteristic that is incompatible with the simulated weapon device 12. For example, the electrical power system 14 may be a positive ground system that is generally incompatible with a particular simulated weapon system 16, such as a military integrated laser engagement system device having a negative ground polarity. As another example, the electrical power system 14 may have a nominal voltage level that is not twenty-four volts direct-current as specified for military integrated laser engagement system devices.

In act 104, electrical power converter 10 may determine the operating characteristics of the electrical power system 14. Upon determining the operating characteristics of the electrical power system 14, the electrical power converter 10 may then adjust electrical power to the simulated weapon device 12 such that the electrical power remains within the specified limits of the simulated weapon device in act 106.

In one embodiment, electrical power may be removed from the simulated weapon device 12 by manipulation of port 30 by external controller 18. Using port 30, electrical power to the simulated weapon device 12 may be controlled without de-coupling the electrical power converter 10 from either electrical power system 12 or simulated weapon device 12 via connector 36 or connector 34, respectively.

The previously described process continues until electrical power is removed from the electrical power system 14 at which time the process is halted in act 108.

An electrical power converter 10 has been described that provides electrical power for simulated weapon devices 16 from the electrical power system 14 of virtually any type of simulated weapon device enabled vehicle 20. Using the electrical power converter 10, the need for additional batteries that remain electrically disconnected from the electrical power system 14 of the vehicle 10 may be alleviated. Thus, other problems inherent with use of additional batteries, such as maintaining the charge level or periodic replacement of the additional batteries may also be alleviated.

Although the present disclosure and its advantages have been described in detail, it should be understood that various changes, substitutions, and alterations can be made therein without departing from the spirit and scope of the disclosure as defined by the appended claims.

What is claimed is:

1. A military training apparatus comprising:
a military integrated laser engagement system device operable to transmit or receive military integrated laser engagement system compliant signals;
a vehicle having an electrical power system with at least one operating characteristic that is incompatible with the military integrated laser engagement system device; and
an electrical power converter coupled between the electrical power system and the military integrated laser engagement system device, the electrical conversion circuit operable to:
receive electrical power from the electrical power system; and
adjust the electrical power provided to the military integrated laser engagement system device such that the electrical power remains within one or more specified limits that is selected from the group consisting of a polarity and a nominal voltage level of the electrical power system.

2. The military training apparatus of claim 1, wherein the electrical power converter is coupled to the military integrated laser engagement system device using a radio rack compliant connector.

3. The military training apparatus of claim 1, wherein the vehicle is a type of vehicle selected from the group consisting of an armored personnel carrier, infantry fighting vehicle, a tank, a sedan, a coupe, a motorcycle, and a truck.

4. A military training apparatus system comprising:
an electrical power converter for coupling between a simulated weapon device and an electrical power system of a vehicle, the electrical power system having at least one operating characteristic that is incompatible with the simulated weapon device, the electrical power converter operable to:
receive electrical power from the electrical power system; and
adjust the electrical power provided to the simulated weapon device such that an operating characteristic of the simulated weapon device remains within one or more specified limits.

5. The military training apparatus of claim 4, wherein the operating characteristic comprises a polarity of the electrical power system.

6. The military training apparatus of claim 4, wherein the operating characteristic comprises a nominal voltage level of the electrical power system.

7. The military training apparatus of claim 4, wherein the vehicle is a type of vehicle selected from the group consisting of an armored personnel carrier, infantry fighting vehicle, a tank, a sedan, a coupe, a motorcycle, and a truck.

8. The military training apparatus of claim 4, wherein the electrical power converter is coupled to an external controller and operable to turn off and on the electrical power to the simulated weapon device in response to a signal from the external controller.

9. The military training apparatus of claim 4, wherein the electrical power converter is further operable to provide a nominal voltage to the simulated weapon device when the input voltage from the electrical power system remains within a specified range.

10. The military training apparatus of claim 9, wherein the specified range is 10.5 to 32.0 volts direct-current.

11. The military training apparatus of claim 9, wherein the nominal voltage is twenty-four volts direct-current.

12. The military training apparatus of claim 4, wherein the simulated weapon device is a military integrated laser engagement system device.

13. The military training apparatus of claim 4, wherein the electrical power converter further comprises a surge suppression circuit that is coupled in between the electrical power system and the simulated weapon device.

14. The military training apparatus of claim 4, wherein the electrical power converter is coupled to the simulated weapon device using a radio rack compliant connector.

15. A method comprising:
receiving electrical power from an electrical power system of a vehicle, the electrical power system having at least one operating characteristic that is incompatible with a simulated weapon device; and
adjusting the electrical power provided to the simulated weapon device such that at least one operating characteristic remains within one or more specified limits of the simulated weapon device.

16. The method of claim 15, and further comprising turning the electrical power to the simulated weapon device on or off in response to a signal from an external controller.

17. The method of claim 15, and further comprising suppressing voltage spikes present on the electrical power system from being transferred to the simulated weapon device.

18. The method of claim 15, wherein adjusting an operating characteristic of the electrical power system further comprises adjusting a voltage level of the electrical power system.

19. The method of claim 15, wherein adjusting an operating characteristic of the electrical power system further comprises adjusting a polarity of the electrical power system.

20. The method of claim 15, wherein receiving electrical power from an electrical power system of a vehicle, the electrical power system having at least one operating characteristic that is incompatible with a simulated weapon device further comprises receiving electrical power from an electrical power system of a vehicle, the electrical power system having at least one operating characteristic that is incompatible with a military integrated laser engagement system device.
